(19) United States
(12) Patent Application Publication
(10) Pub. No.: US 2016/0295925 A1
(43) Pub. Date: Oct. 13, 2016

(54) ATOMIZATION CORE OF ELECTRONIC CIGARETTE

(71) Applicant: Chuhui Chen, Shenzhen (CN)

(72) Inventor: Chuhui Chen, Shenzhen (CN)

(21) Appl. No.: 15/065,434

(22) Filed: Mar. 9, 2016

(30) Foreign Application Priority Data
Apr. 7, 2015 (CN) 201510160420.0

(51) Int. Cl. A24F 47/00; H05B 3/00; H05B 1/02

(52) U.S. Cl. CPC A24F 47/008; H05B 1/0244; H05B 3/0014

(57) ABSTRACT

The present invention relates to an atomization core of an electronic cigarette comprising an atomization chamber and an electric heating wire, wherein the electric heating wire is distributed in the atomization chamber, wherein an liquid intake hole is provided on the top of the atomization chamber, and wherein the a vent hole is provided on the atomization chamber; wherein the atomization chamber is made of a ceramic material; wherein the atomization core further comprising a housing, wherein the housing covers the periphery of the atomization chamber, wherein a vent hole is provided on the housing, and wherein the vent hole and the liquid intake hole form a through passage; wherein the housing further comprising an exhaust hole.

### FIELD OF THE INVENTION

The invention relates to an atomization core of an electronic cigarette.

### BACKGROUND OF THE INVENTION

The structure of a conventional structure atomization core of an electronic cigarette typically comprises a fiberglass rope, organic cotton or other liquid conduit immersed in e-liquid in a liquid reservoir. The smoke liquid enters the inner part of the atomization core through a liquid conduit to be heated and atomized. The conventional atomization core has two major disadvantages: first, the quality of vapor is affected by soaking the liquid conduit with the e-liquid; second, the material of the liquid conduit may contain substances that are dangerous to health.

As to the first disadvantage, due to the long-term use of electronic cigarette, the smoke liquid soaked in by the liquid conduit may produce qualitative change after being deposited on the liquid conduit for an extended period of time. As a result, undesirable odor may be generated by the electronic cigarette giving the cigarette vapor a foul taste.

As to the second disadvantage, the material used for the liquid conduit currently available in the market are mainly fiberglass rope or the organic cotton, both are mainly composed of a fiber, and fiber presents a major health risk when inhaled into the lung.

### SUMMARY OF THE INVENTION

The objective of the present invention is to provide an atomization core which does not have negative influence on the taste of vapor and minimizes health risk by preventing fiber from being inhaled into the lungs of its user.

According one embodiment the invention, an atomization core of an electronic cigarette can comprise an atomization chamber and an electric heating wire, wherein the electric heating wire is distributed in the atomization chamber in a predetermined manner, wherein the top of the atomization chamber is provided with a liquid intake hole, wherein the atomization chamber is provided with a vent hole.

In some embodiments, the atomization chamber can be made of ceramic material.

In some embodiments, the atomization chamber can comprise a housing, wherein the housing covers a periphery of the atomization chamber, wherein the housing is provided with a vent hole, and wherein the vent hole forms a through passage with the liquid intake hole.

In some embodiments, the housing can be provided with an exhaust hole.

A structure of the atomization core of the electronic cigarette differs from the structure of a conventional atomization core in that the e-liquid enters the atomization chamber through a liquid conduit, but rather infiltrates the atomization chamber through a passage. When a user inhales on the cigarette, negative pressure is created to pull the e-liquid from the liquid intake hole into the atomization chamber. The present invention prevents fiber in the liquid conduit from being inhaled into user's lung. Furthermore, the an liquid reservoir in the present invention can be a vacuum hence allowing the e-liquid to infiltrate naturally into the atomization chamber through the liquid intake hole in an extremely slow fashion. As a result, this structure will not produce undesirable odor generated by soaking the liquid conduit with e-liquid for extended period of time, thereby effectively increasing the service life of the atomization core.

### BRIEF DESCRIPTION OF THE DRAWINGS

FIG. 1 is a structure diagram of an atomization core of an electronic cigarette according to an embodiment of the invention;

FIG. 2 is a structure diagram of an atomization chamber of according an embodiment of the invention;

FIG. 3 is a front view of the atomization chamber according to an embodiment;

FIG. 4 is a sectional view of an atomization chamber according to an embodiment; and

FIG. 5 is a sectional view of an atomization core of an electronic cigarette according to another embodiment.

### DETAILED DESCRIPTION

In the following detailed description, reference is made to the accompanying drawings that form a part hereof, and in which is shown by way of illustration specific implementations that may be practiced. These implementations are described in sufficient detail to enable those skilled in the art to practice the implementations, and it is to be understood that other implementations may be utilized and that logical, mechanical, electrical and other changes may be made without departing from the scope of the implementation. The following detailed description is, therefore, not to be taken in a limiting sense.

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

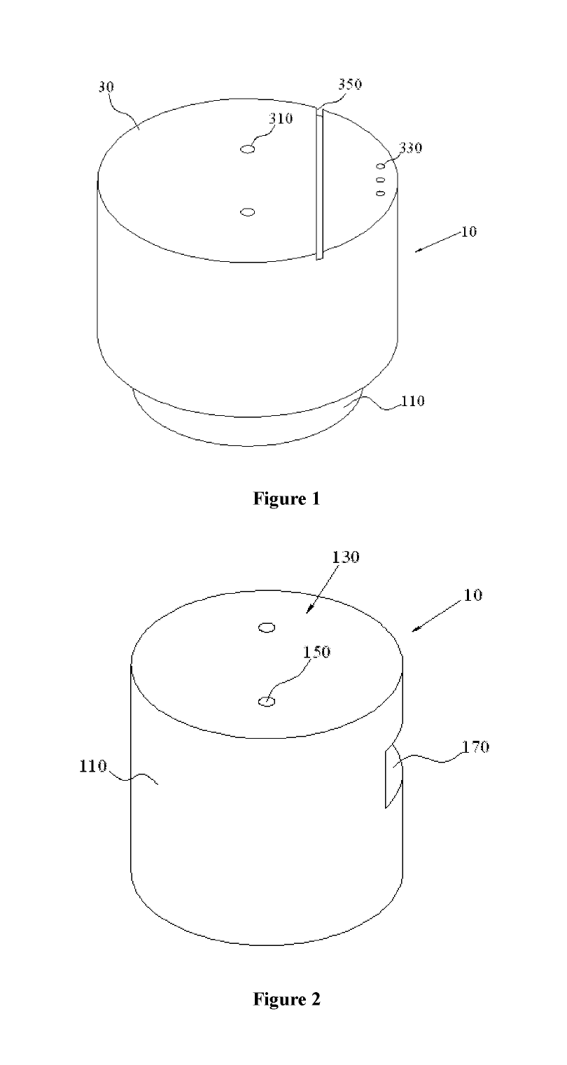

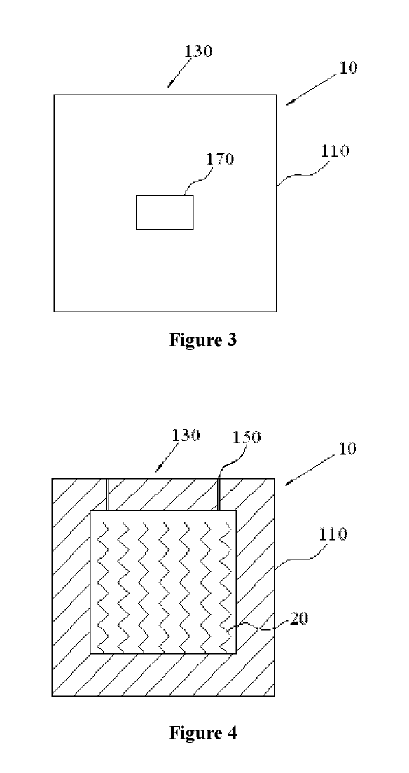

Referring to FIGS. 1 to 5, the atomization core 10 of an electronic cigarette according to an embodiment of the invention can comprise an atomization chamber 110 and an electric heating wire 20, wherein the electric heating wire 20 is evenly distributed inside the atomization chamber 110, wherein two liquid intake holes 150 and a glass liquid reservoir (not shown) are provided on the top 130 of the atomization chamber 110 , and a vent hole 170 is provided on the side of the atomization chamber 110.

In one embodiment, a periphery of the atomization chamber 110 is covered with a housing 30. Two vent holes 310 are provided on the housing 30, and the vent hole 310 and the oil intake holes 150 are correspondingly aligned to form a through passage. One end of the through passage is connected to the atomization chamber 110 and the other end of the through passage is reaches the outer surface of the housing 30. The housing 30 is provided with three exhaust holes 330.

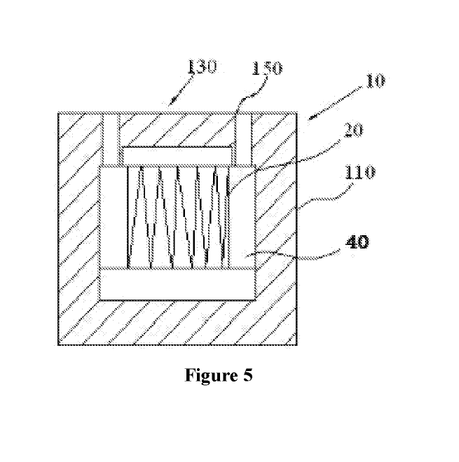

In one embodiment, the atomization chamber 110 is made of a ceramic material. As shown in FIG. 5, e-liquid can be disposed into the atomization chamber 110 through a ceramic rod 40 through the liquid intake hole 150. A vent hole 310, a liquid intake hole 150 and the ceramic rod 40 form a complete passage. In this embodiment, the ceramic rod 40 is supported in the atomization chamber 110, and the electric heat wire 20 is disposed about the ceramic rod 40 in a predetermined pattern. After taking in the e-liquid, the ceramic rod 40 distributes the e-liquid in the atomization chamber 110, and the electric heating wire 20 heats the e-liquid and atomizes the e-liquid. The vapor generated by the atomization of the e-liquid is discharged through the vent hole 170.

The housing 30 can be used to connect the atomization chamber 110 of the electric cigarette with a glass liquid reservoir. Specifically, the inner side of the housing 30 covers the atomization chamber 110, the outer side of the housing 30 is connected to the glass oil reservoir. The e-liquid in the glass liquid reservoir passes through the vent hole 310 and the oil intake hole 150 to reach the atomization chamber 110.

The housing 30 covers the periphery of the atomization chamber 110, separating the atomization chamber 110 from the e-liquid. Since the glass liquid reservoir of in an electronic cigarette is typically a vacuum, e-liquid passes through the vent hole 310 to infiltrated into the atomization chamber 110 only in small quantities. Another function of the housing 30 is to guide the vapor generated in the atomization chamber 110 to a mouthpiece through the exhaust hole 330.

In one embodiment, the liquid intake hole 150 is used to guide the e-liquid from the glass liquid reservoir to the atomization chamber 110. In this embodiment, two liquid intake holes 150 are provided on the atomization chamber 110. The plurality of intake holes 150 makes a more even distribution of e-liquid into the ceramic rod 40. The amount of the smoke oil entering the atomization chamber in unit/time is affected by the size of the oil intake hole 150, the type of e-liquid, the smoking habits of a user, the structure of the electronic cigarette and other factors. Therefore, it can be understood that the liquid intake hole 150 is not limited to one specification but can be suitably adjusted according to specific structure of the electronic cigarette and the demand of the user.

The above embodiments only describe one or several embodiments of the invention, its description is more concreted and detailed but cannot hence be understood to limit the scope of the patent of the invention. It should be pointed out that those skilled in the art can also make a plurality of modifications and improvements without departing from the concept of the invention, which all belong to the protection scope of the invention. Therefore, for the protection scope of the patent of the invention, the appended claims should prevail.

1. An atomization core of an electronic cigarette, comprising an atomization chamber and an electric heating wire, wherein the electric heating wire is distributed in the atomization chamber, wherein an liquid intake hole is provided on the top of the atomization chamber, and wherein the a vent hole is provided on the atomization chamber.

2. The atomization core of an electric cigarette according to claim 1, wherein the atomization chamber is made of a ceramic material.

3. An atomization core of an electric cigarette according to claim 1, wherein the atomization core further comprising a housing, wherein the housing covers the periphery of the atomization chamber, wherein a vent hole is provided on the housing, and wherein the vent hole and the liquid intake hole form a through passage.

4. An atomization core of an electric cigarette according to claim 3, wherein the housing further comprising an exhaust hole.
